(19) United States
(12) Patent Application Publication
(10) Pub. No.: US 2021/0247763 A1
(43) Pub. Date: Aug. 12, 2021

(54) CONTROL DEVICE, CONTROL METHOD, AND PROGRAM

(71) Applicant: SONY CORPORATION, TOKYO (JP)

(72) Inventors: TAKARA KASAI, TOKYO (JP); TAKASHI KITO, TOKYO (JP); KAZUO HONGO, TOKYO (JP); RYOTA KIMURA, TOKYO (JP)

(21) Appl. No.: 15/734,725

(22) PCT Filed: Mar. 29, 2019
(86) PCT No.: PCT/JP2019/014027

§ 371 Date: Dec. 3, 2020

(30) Foreign Application Priority Data
Jun. 12, 2018 (JP) 2018-111521

(51) Int. Cl. G05D 1/00; G05D 1/02; B25J 11/00

(52) U.S. Cl. CPC G05D 1/0061; G05D 1/0016; B25J 11/008; G05D 1/0022; G05D 1/0221; G05D 1/0088

(57) ABSTRACT

[Problem] It becomes possible to switch the operation controlling entity while maintaining continuity in the tasks.

[Solution] A control device includes a driving control unit that drives a robot device based on one of a first-type driving instruction and a second-type driving instruction, at least one of which is sent from a distant location from the robot device; and a transition control unit that switches a driving instruction for driving the robot device from the first-type driving instruction to the second-type driving instruction. The transition control unit switches the driving instruction from the first-type driving instruction to the second-type driving instruction via a transition driving instruction generated based on the first-type driving instruction and the second-type driving instruction.

### FIELD

The application concerned is related to a control device, a control method, and a program.

### BACKGROUND

In recent years, with the decline in the working population and with the development of the robot technology, there is anticipation about having robot devices developed as an alternative to human work.

Such robot devices are demanded to perform operations in an autonomous manner. However, at present, since only limited tasks are executable by robot devices, it is difficult for robot devices to substitute for human work in its entirety. Moreover, at present, such robot devices are low in stability in terms of task execution. Hence, if there is a change in the work environment or the work target, the same tasks may or may not be successfully executed.

In that regard, as far as introducing robot devices is concerned, it is under consideration to make robot devices perform some of the autonomously-executable tasks and, regarding the tasks that are not autonomously executable by robot devices, to make robot devices perform those tasks via human remote control.

As a system in which robot devices are controlled via autonomous control and via remote control, for example, a robot control system is known as disclosed in Patent Literature 1 mentioned below. More particularly, in Patent Literature 1, regarding an autonomous mobile robot capable of moving around in an autonomous manner, when the autonomous mobile robot cannot perform autonomous movements, the operation controlling entity is switched from the autonomous mobile robot itself to human remote control.

### CITATION LIST

### Patent Literature

Patent Literature 1: Japanese Laid-open Patent Publication No. 11-149315

### SUMMARY

### Technical Problem

In the robot control system disclosed in Patent Literature 1, the switching of the operation controlling entity from the autonomous mobile robot to human remote control is performed after de-actuating the autonomous mobile robot. For that reason, in the robot control system disclosed in Patent Literature 1, before and after switching the operation controlling entity, it is sometimes difficult to maintain continuity in the movement path and the movement speed of the autonomous mobile robot.

However, in a robot device that serves as a substitute for human work and performs more complex tasks, inability to maintain continuity in the tasks before and after switching the operation controlling entity has an impact on whether or not the tasks are successful. Moreover, every time the operation controlling entity is switched, if the robot device is de-actuated and is controlled in a neutral state having no impact on the tasks, it causes a decline in the efficiency of the tasks performed by the robot device.

Hence, regarding a robot device for which the operation controlling entity can be switched, there is a demand for a technology that enables switching the operation controlling entity while maintaining continuity in the tasks.

### Solution to Problem

According to the present disclosure, a control device is provided. The control device includes a driving control unit that drives a robot device based on one of a first-type driving instruction and a second-type driving instruction, at least one of which is sent from a distant location from the robot device and a transition control unit that switches a driving instruction for driving the robot device from the first-type driving instruction to the second-type driving instruction, wherein the transition control unit switches the driving instruction from the first-type driving instruction to the second-type driving instruction via a transition driving instruction generated based on the first-type driving instruction and the second-type driving instruction.

Moreover, according to the present disclosure, a control method implemented in an arithmetic processing device is provided. The control method includes driving a robot device based on a first-type driving instruction from among the first-type driving instruction and a second-type driving instruction, at least one of which is sent from a distant location from the robot device and switching a driving instruction for driving the robot device from the first-type driving instruction to the second-type driving instruction via a transition driving instruction generated based on the first-type driving instruction and the second-type driving instruction.

Moreover, according to the present disclosure, a program that causes a computer to function as a driving control unit that drives a robot device based on one of a first-type driving instruction and a second-type driving instruction, at least one of which is sent from a distant location from the robot device and a transition control unit that switches driving instruction for driving the robot device from the first-type driving instruction to the second-type driving instruction. The program causes the transition control unit to switch a driving instruction from the first-type driving instruction to the second-type driving instruction via a transition driving instruction generated based on the first-type driving instruction and the second-type driving instruction.

According to the present disclosure, a transition driving instruction can be generated based on each driving instruction received from the pre-switching operation controlling entity and the post-switching operation controlling entity for the robot device, and the operation controlling entity for the robot device can be switched via the transition driving instruction.

### Advantageous Effects of Invention

According to the present disclosure as explained above, it becomes possible to switch the operation controlling entity while maintaining continuity in the tasks.

Meanwhile, the abovementioned effect is not necessarily limited in scope and, in place of or in addition to the abovementioned effect, any other effect indicated in the present written description or any other effect that may occur from the present written description can also be achieved.

### BRIEF DESCRIPTION OF DRAWINGS

FIG. 1 is an explanatory diagram for explaining the overview of a control device according to an embodiment of the application concerned.

FIG. 2 is a block diagram illustrating an exemplary functional configuration of the control device according to the embodiment.

FIG. 3 is a block diagram illustrating a specific example of the functional configuration of a transition control unit.

FIG. 4A is a graph illustrating an example of a first-type driving instruction received from a first external controller.

FIG. 4B is a graph illustrating an example of a second-type driving instruction received from a second external controller.

FIG. 4C is a graph illustrating a transition function used in the weighting of the first-type driving instruction and the second-type driving instruction.

FIG. 4D is a graph illustrating an example of a transition driving instruction that is generated.

FIG. 5 is a block diagram illustrating a specific example of the functional configuration of the transition control unit when the operation controlling entity for a robot device is switched between the first external controller and the control device.

FIG. 6 is a flowchart for explaining an example of the operations performed in the control device according to the embodiment.

FIG. 7 is a sequence diagram illustrating an example of the operations performed in the control device according to the embodiment.

FIG. 8 is a block diagram illustrating a specific example of the functional configuration of a control device according to a first modification example.

FIG. 9 is a block diagram illustrating a specific example of the functional configuration of a control device according to a second modification example.

FIG. 10 is a block diagram illustrating an exemplary hardware configuration of the control device according to the embodiment.

### DESCRIPTION OF EMBODIMENTS

A preferred embodiment of the application concerned is described below in detail with reference to the accompanying drawings. In the present written description and the drawings, the constituent elements having practically identical functional configuration are referred to by the same reference numerals, and the explanation is not given repeatedly.

The explanation is given in the following sequence.
1. Overview
2. Configuration
3. Specific example of configuration
4. Example of operations
5. Modification examples
6. Exemplary hardware configuration

### 1. Overview

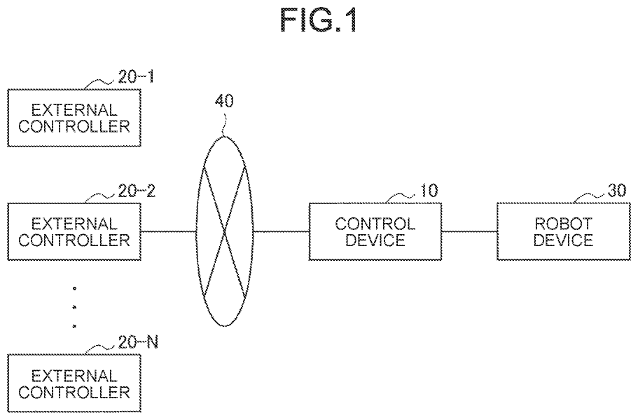

Firstly, explained below with reference to FIG. 1 is the overview of a control device according to the present embodiment of the application concerned. FIG. 1 is an explanatory diagram for explaining the overview of the control device according to the present embodiment.

As illustrated in FIG. 1, a control device 10 is connected to a robot device 30 and controls the driving of the robot device 30. Moreover, the control device 10 is connected to a plurality of external controllers 20-1 to 20-N via a network 40. Based on driving instructions input from each of the external controllers 20-1 to 20-N, the control device 10 can control the driving of the robot device 30. Meanwhile, the control device 10 can be alternatively installed as part of the robot device 30.

The robot device 30 is a robot that performs operations based on the driving instructions received from the control device 10. The operation controlling entity for the robot device 30 is switched by the control device 10, so that the driving of the robot device 30 is controlled based on the driving instructions from one of a plurality of operation controlling entities. For example, the driving of the robot device 30 can be controlled based on the driving instructions input from the external controllers 20-1 to 20-N or based on the driving instructions that are autonomously generated in the control device 10. The robot device 30 can be, for example, a robot device aimed at functioning as a substitute for human work, or can be a remote control manipulator or a housekeeping support robot.

The external controllers 20-1 to 20-N represent input devices to which driving instructions for the robot device 30 are input by the respective operators. More particularly, the external controllers 20-1 to 20-N are installed at distant locations from the robot device 30, and enable the respective operators to perform remote control of the robot device 30. For example, the external controllers 20-1 to 20-N can be input devices that include an input mechanism such as a touch-sensitive panel, buttons, switches, or levers. Each of the external controllers 20-1 to 20-N generates driving instructions based on the input by an operator, and sends the generated driving instructions to the robot device 30 via the network 40.

The network 40 is a communication network enabling communication of information with distant locations. The network 40 enables the relay of driving instructions for the robot device 30 from the external controllers 20-1 to 20-N, which are installed at mutually distant locations, to the control device 10. For example, the network 40 can be a public communication network such as the Internet, a satellite communication network, or a telephone network; or can be a communication network installed in a limited area, such as a LAN (Local Area Network) or a WAN (Wide Area Network).

Thus, the control device 10 receives driving instructions from a plurality of operation controlling entities, and outputs the received driving instructions to the robot device 30. For example, the control device 10 can output, to the robot device 30, either the driving instructions input from the external controllers 20-1 to 20-N or the driving instructions autonomously generated in the control device 10. Thus, by switching among the driving instructions to be output to the robot device 30, the control device 10 can switch among the operation controlling entities that control the driving of the robot device 30.

At the time of switching the operation controlling entity for the robot device 30, the control device 10 generates a transition driving instruction based on the driving instructions received from the pre-switching operation controlling entity and the post-switching operation controlling entity; and outputs the transition driving instruction to the robot device 30. More particularly, the control device 10 outputs, to the robot device 30, a transition driving instruction that is generated by performing weighted synthesis of the driving instructions received from the pre-switching operation controlling entity and the post-switching operation controlling entity. As a result, the control device 10 becomes able to switch, in continuity, from the driving instructions from the pre-switching operation controlling entity to the driving instructions from the post-switching operation controlling entity, and hence can maintain continuity in the operations of the robot device 30.

In the present embodiment, the driving of the robot device 30 can be controlled by a plurality of operation controlling entities such as the external controllers 20-1 to 20-N and the control device 10. Hence, in the present embodiment, the operation controlling entities that instruct the driving do not have a one-to-one correspondence with the robot device 30. More particularly, the number of robot devices 30 and the number of operators of the robot devices 30 has an asymmetric ratio of N:M. Hence, in the present embodiment, it is possible to think that the combination of the robot device 30 and the operation controlling entity for the robot device 30 changes in a dynamic manner.

For example, in a housekeeping support robot, if it becomes difficult to continue with the cooking tasks under the autonomous control, it is possible to think of switching the operation controlling entity for the housekeeping support robot to an operator capable of performing remote control. Moreover, in a manipulator device, if the complexity of the tasks increases thereby making it difficult to continue with the tasks under the control of an operator A, it is possible to think of switching the operation controlling entity for the manipulator device to a more trained operator B. Furthermore, when a single operator is operating a plurality of robot devices, it is possible to think of switching the operation controlling entities for some of those robot devices to other operators.

In the control device 10 according to the present embodiment, when the operation controlling entity for the robot device 30 is dynamically switched as explained above, the operation controlling entity can be switched while maintaining the task states of the tasks being carried out. Hence, the control device 10 according to the present embodiment can make the robot device 30 perform tasks with more efficiency.

Given below is the detailed explanation of a specific configuration of the control device 10 according to the present embodiment.

### 2. Configuration

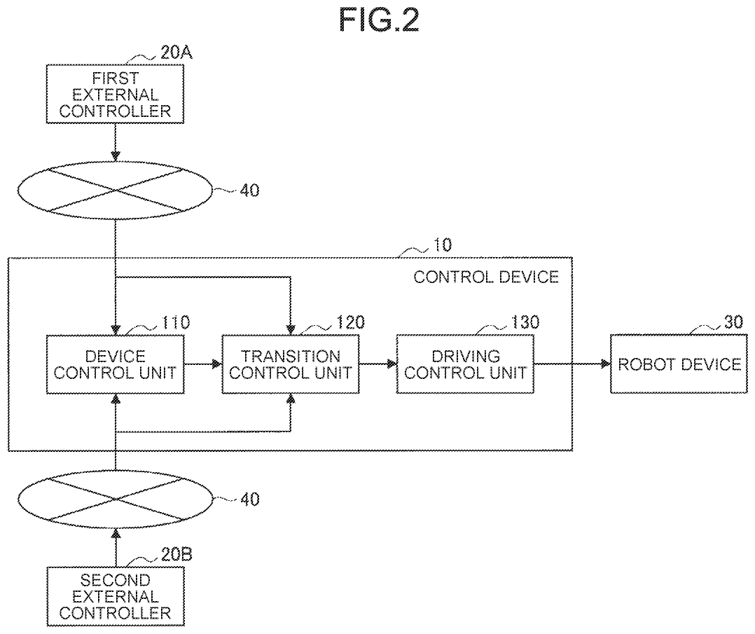

Explained below with reference to FIG. 2 is an exemplary functional configuration of the control device 10 according to the present embodiment. FIG. 2 is a block diagram illustrating an exemplary functional configuration of the control device 10 according to the present embodiment.

As illustrated in FIG. 2, the control device 10 receives driving instructions for the robot device 30 from either one of a first external controller 20A and a second external controller 20B that are installed at distant locations; and controls the driving of the robot device 30 according to the received driving instructions. Moreover, the control device 10 switches between the first external controller 20A and the second external controller 20B for outputting the corresponding driving instructions to the robot device 30.

The first external controller 20A and the second external controller 20B represent input devices that are installed at distant locations from the robot device 30 and that are used by the respective operators to input driving instructions for the robot device 30. Meanwhile, in FIG. 2, although only the first external controller 20A and the second external controller 20B are illustrated, the control device 10 can perform communication also with other external controllers (not illustrated) via the network 40.

The network 40 is a network for enabling communication of information with distant locations. Thus, the network 40 relays communication of information from the first external controller 20A and the second external controller 20B to the control device 10.

The robot device 30 is a robot device that is controllable based on the driving instructions input from the first external controller 20A or the second external controller 20B.

Given below is the explanation of an internal configuration of the control device 10. The control device 10 includes a device control unit 110, a transition control unit 120, and a driving control unit 130. Meanwhile, the control device 10 can also be installed as part of the robot device 30.

The device control unit 110 controls the overall operations of the control device 10. More particularly, the device control unit 110 controls the switching of the operation controlling entity for the robot device 30 between the first external controller 20A and the second external controller 20B.

Moreover, the device control unit 110 can figure out the communication state with the first external controller 20A or the second external controller 20B, and can control the operations of the control device 10 based on the communication state. For example, the device control unit 110 can manage the communication stability and the communication delay in the communication with the first external controller 20A or the second external controller 20B. As a result, based on the communication stability and the communication delay in the communication with the first external controller 20A or the second external controller 20B, the control device 10 can stop the switching of the operation controlling entity for the robot device 30.

Moreover, when the robot device 30 is not being remote-controlled using the first external controller 20A or the second external controller 20B, the device control unit 110 can generate driving instructions for making the robot device 30 perform autonomous operations.

The driving control unit 130 controls the operations of the robot device 30 based on the driving instructions output from the transition control unit 120. More particularly, based on the driving instructions output from the transition control unit 120, the driving control unit 130 controls the magnitude of the torque applied to each joint of the robot device 30 and controls the driving amount of each actuator of the robot device 30, and accordingly makes the robot device 30 perform desired operations.

The transition control unit 120 switches the driving instruction to be output to the robot device 30 from a first-type driving instruction received from the first external controller 20A to a second-type driving instruction received from the second external controller 20B. At that time, the transition control unit 120 switches from a first-type driving instruction to a second-type driving instruction via a transition driving instruction that is generated based on the first-type driving instruction and the second-type driving instruction. As a result, when the driving instruction to be output to the robot device 30 is switched from a first-type driving instruction to a second-type driving instruction, the transition control unit 120 becomes able to prevent discontinuity from occurring in the operations of the robot device 30.

More particularly, the transition control unit 120 generates a transition driving instruction by performing weighted synthesis of the first-type driving instruction and the second-type driving instruction based on a transition function undergoing monotonic increase or monotonic decrease. As a result, the transition control unit 120 becomes able to generate a transition driving instruction for gradually switching the weighting from the state in which the first-type driving instruction has a greater weight and the second-type driving instruction has a smaller weight to the state in which the first-type driving instruction has a smaller weight and the second-type driving instruction has a greater weight. By switching from the first-type driving instruction to the second-type driving instruction via such a transition driving instruction, the transition control unit 120 can switch from the first-type driving instruction to the second-type driving instruction with continuity and smoothness.

Meanwhile, at the time of controlling the switching from the first-type driving instruction to the second-type driving instruction using a transition driving instruction, the transition control unit 120 either can stop or can immediately finish the switching from the first-type driving instruction to the second-type driving instruction.

For example, if the communication state between the control device 10 and the first external controller 20A or the second external controller 20B becomes unstable or if something goes wrong in the first external controller 20A or the second external controller 20B, there are times when it becomes difficult to control the driving of the robot device 30 using any one operation controlling entity. In such a case, the transition control unit 120 either can stop or can immediately finish the switching from the first-type driving instruction to the second-type driving instruction, so as to perform control in such a way that the robot device 30 is driven according to either only the first-type driving instruction or only the second-type driving instruction.

Meanwhile, whether to stop or immediately finish the switching from the first-type driving instruction to the second-type driving instruction can be determined by the operator of the first external controller 20A or the operator of the second external controller 20B. With that, based on the instruction from the operator, the transition control unit 120 can control stopping or immediately finishing the switching from the first-type driving instruction to the second-type driving instruction.

### 3. Specific Example of Configuration

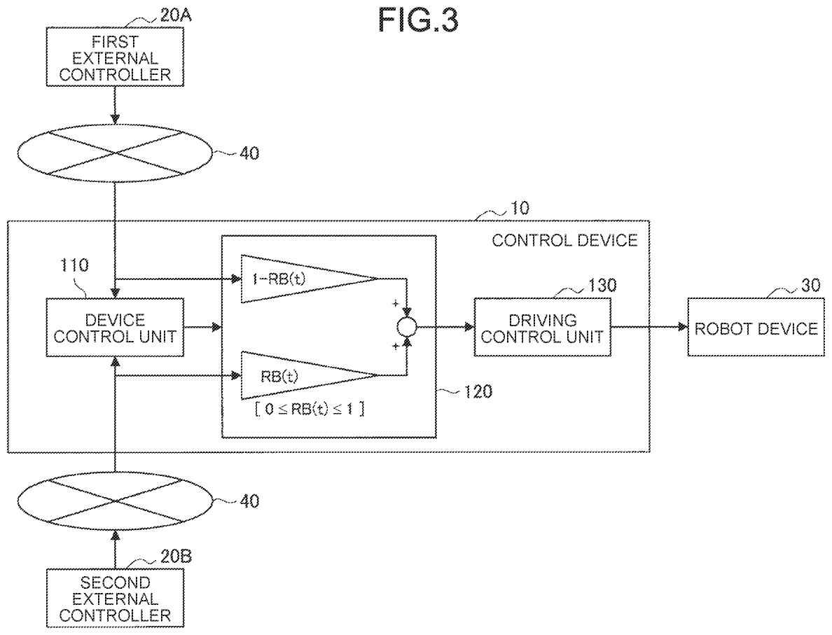

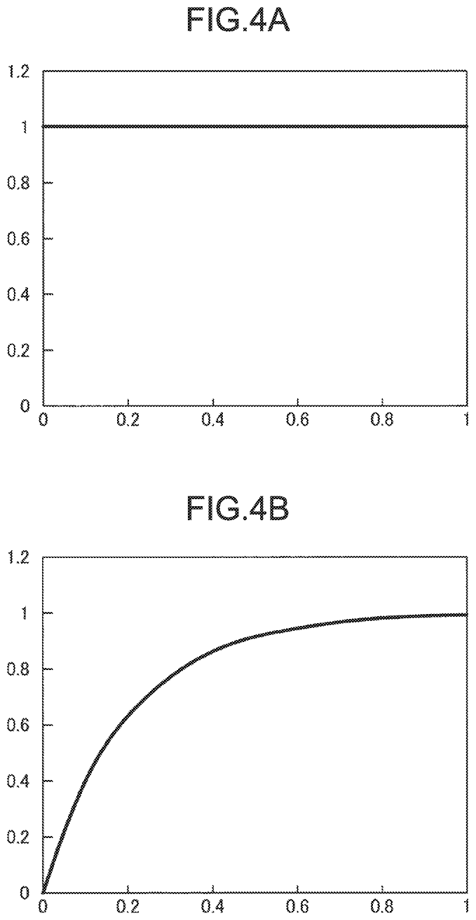

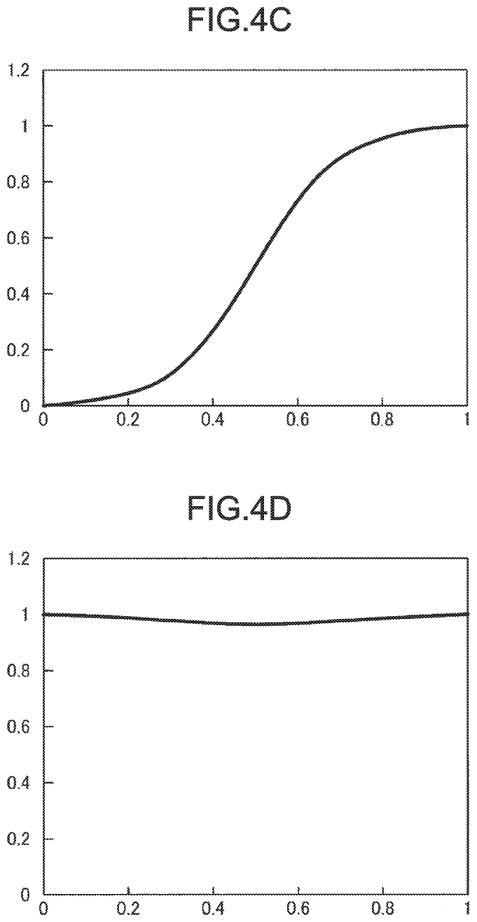

Explained below with reference to FIGS. 3 to 4D is a specific example of the functional configuration of the transition control unit 120. FIG. 3 is a block diagram illustrating a specific example of the functional configuration of the transition control unit 120.

FIG. 4A is a graph illustrating an example of a first-type driving instruction received from the first external controller 20A. FIG. 4B is a graph illustrating an example of a second-type driving instruction received from the second external controller 20B. FIG. 4C is a graph illustrating a transition function used in the weighting of the first-type driving instruction and the second-type driving instruction. FIG. 4D is a graph illustrating an example of the transition driving instruction that is generated. In the graphs illustrated in FIGS. 4A to 4D, the horizontal axis represents time and the vertical axis represents the amount of operations with respect to a configuration of the robot device 30.

As illustrated in FIG. 3, the transition control unit 120 switches the state from the state in which the control of the driving of the robot device 30 is performed using only the first-type driving instruction received from the first external controller 20A to the state in which the control of the driving of the robot device 30 is performed using only the second-type driving instruction received from the second external controller 20B.

At that time, the transition control unit 120 generates a transition control instruction by synthesizing the result of applying “1-RB(t)” to the first-type driving instruction received from the first external controller 20A and the result of applying “RB(t)” to the second-type driving instruction received from the second external controller 20B. Herein, RB(t) represents a transition function that undergoes monotonic increase in the range between 0 and 1. For example, RB(t) can be a function expressed using Equation 1 given below.

RB(t)=1/(1+exp(−5×2(t/T−1)) Equation 1

In Equation 1, t represents the elapsed time since the start of the switching from the first-type driving instruction to the second-type driving instruction; and T represents the period of time taken till the completion of the switching from the first-type driving instruction to the second-type driving instruction (hereinafter, also called transition period). The transition period can be equal to a predetermined period of time (for example, one second to about a few seconds), or can be a period of time arbitrarily set by the operator of the first external controller 20A or the operator of the second external controller 20B.

As a result, in an intermediate state during the switching from the first-type driving instruction to the second-type driving instruction, the driving amount of the robot device 30 becomes equal to the weighted addition of the driving amount according to the first-type driving instruction and the driving amount according to the second-type driving instruction, with the total of the weights being equal to “1”. Hence, at the time of switching from the first-type driving instruction to the second-type driving instruction, the transition control unit 120 can generate a transition driving instruction in such a way that the driving amount of the robot device 30 changes smoothly and with continuity.

For example, when the first-type driving instruction is switched to the second-type driving instruction; in the robot device 30, as illustrated in FIG. 4A, it is believed that the first-type driving instruction representing the switching source is instructing the appropriate driving amount according to the task states of the robot device 30. On the other hand, as illustrated in FIG. 4B, it is believed that, at the start of the switching, the second-type driving instruction representing the switching destination is not able to instruct the appropriate driving amount according to the task states of the robot device 30, and gradually becomes able to instruct the appropriate driving amount. That is because, at the start of the switching, the operator of the second external controller 20B is likely to have not figured out the task states of the robot device 30 or is likely to have not figured out the appropriate maneuvering feeling of the robot device 30.

The transition control unit 120 can perform weighted synthesis of the first-type driving instruction, which is instructing the appropriate driving amount, and the second-type driving instruction, which is less likely to be instructing the appropriate driving amount; and then can gradually vary the weighting of the synthesis. As a result, at the time of switching from the first-type driving instruction to the second-type driving instruction, the transition control unit 120 can maintain the appropriate driving amount according to the task states of the robot device 30.

For example, the transition control unit 120 can control the weighting of the first-type driving instruction and the second-type driving instruction using the transition function RB(t) illustrated in FIG. 4C. The transition function RB(t) illustrated in FIG. 4C represents the graphical representation of Equation 1 given above. Using the transition function RB(t) illustrated in FIG. 4C, the transition control unit 120 can synthesize the first-type driving instruction illustrated in FIG. 4A and the second-type driving instruction illustrated in FIG. 4B, and can generate the transition driving instruction illustrated in FIG. 4D. As a result, before and after the switching from the first-type driving instruction to the second-type driving instruction, the transition control unit 120 can hold down the fluctuation in the driving amount of the robot device 30. Hence, the switching from the first-type driving instruction to the second-type driving instruction can be performed more smoothly.

The explanation till now was given about the example in which the control device 10 switches the operation controlling entity for the robot device 30 from the first external controller 20A to the second external controller 20B. However, the present embodiment is not limited to that example. Alternatively, for example, the control device 10 can switch the operation controlling entity for the robot device 30 from the first external controller 20A to the control device 10, or can switch the operation controlling entity for the robot device 30 from the control device 10 to the first external controller 20A. That is, the control device 10 can switch the operation controlling entity for the robot device 30 among a plurality of external controllers performing remote control of the robot device 30; or can switch the operation controlling entity for the robot device 30 between an external controller that performs remote control of the robot device 30 and the control device 10 that autonomously drives the robot device 30.

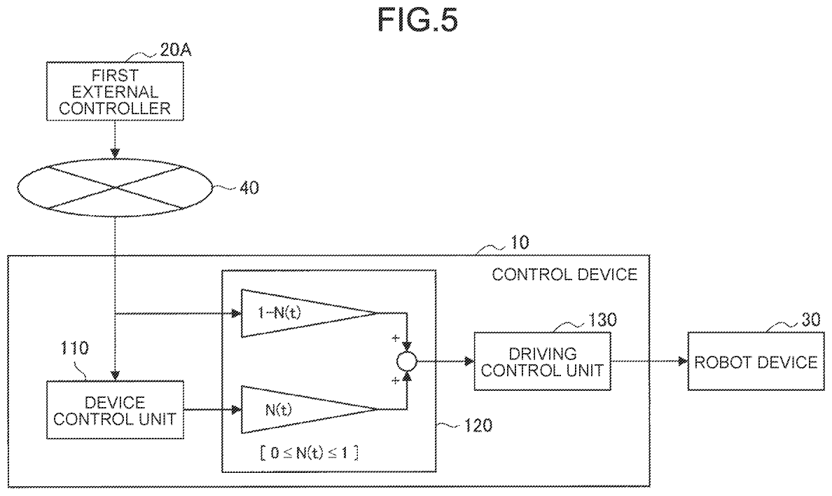

The explanation of the abovementioned example is given with reference to FIG. 5. FIG. 5 is a block diagram illustrating a specific example of the functional configuration of the transition control unit 120 when the operation controlling entity for the robot device 30 is switched between the first external controller 20A and the control device 10.

As illustrated in FIG. 5, the transition control unit 120 switches the state from the state in which the driving of the robot device 30 is controlled only according to an autonomous driving instruction generated in the control device 10 to the state in which the driving of the robot device 30 is controlled only according to a first-type driving instruction received from the first external controller 20A.

At that time, the transition control unit 120 generates a transition control instruction by synthesizing the result of applying “N(t)” to the autonomous driving instruction generated by the device control unit 110 and the result of applying “1-N(t)” to the first-type driving instruction received from the first external controller 20A. Herein, N(t) can be a transition function that undergoes monotonic increase or monotonic decrease in the range between 0 and 1.

The transition period taken till the completion of the switching from the autonomous driving instruction to the first-type driving instruction can be equal to a predetermined period of time (for example, one second to about a few seconds), or can be a period of time arbitrarily set by the operator of the first external controller 20A.

As a result, in an intermediate state during the switching from the autonomous driving instruction to the first-type driving instruction, the driving amount of the robot device 30 becomes equal to the weighted addition of the driving amount according to the autonomous driving instruction and the driving amount according to the first-type driving instruction, with the total of the weights being equal to “1”. Hence, at the time of switching from the autonomous driving performed by the control device 10 to the remote control performed by the first external controller 20A, the transition control unit 120 can generate a transition driving instruction in such a way that the driving amount of the robot device changes with continuity.

### 4. Example of Operations

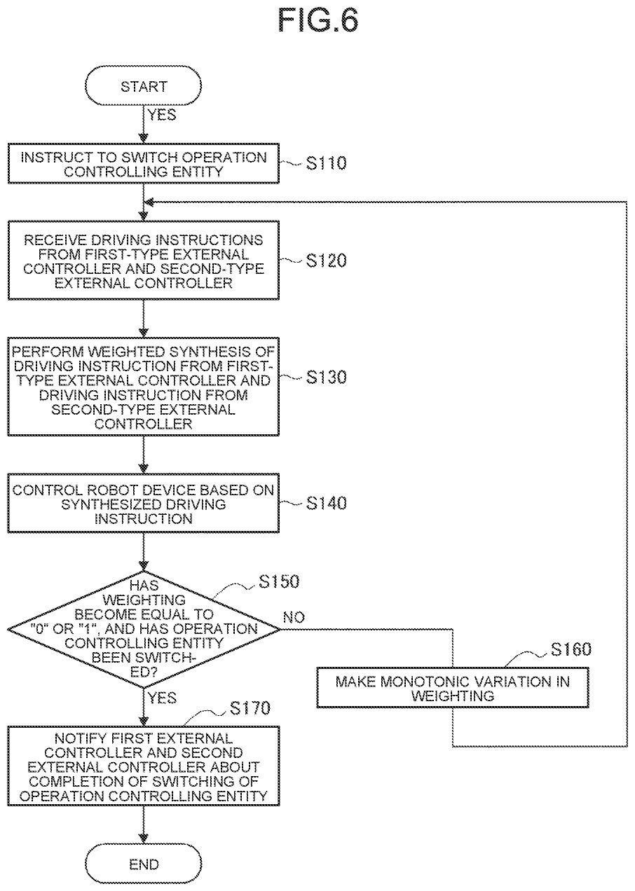

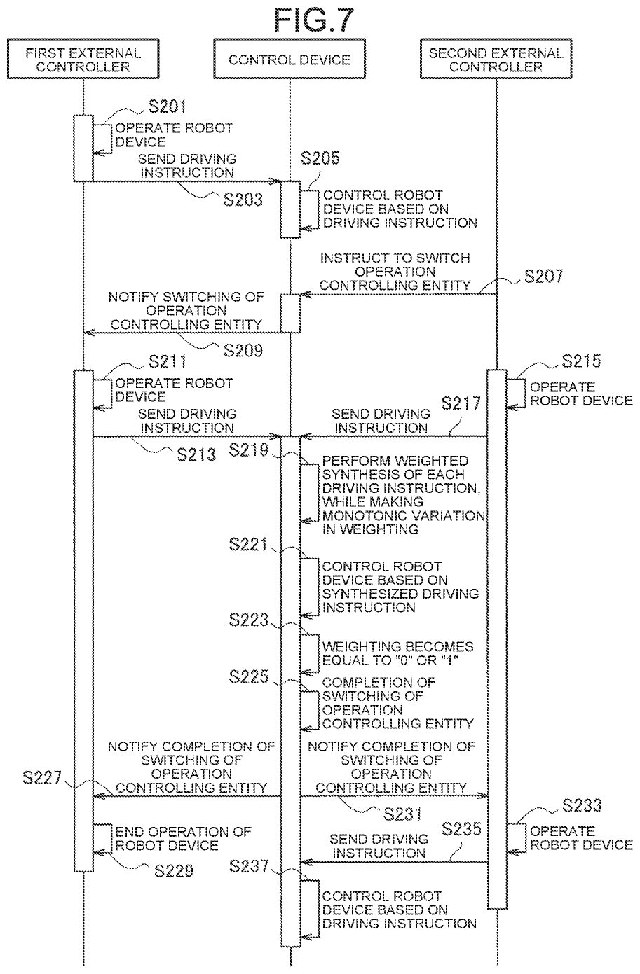

Explained below with reference to FIGS. 6 and 7 is an example of the operations performed in the control device 10 according to the present embodiment.

Firstly, explained with reference to FIG. 6 is the flow of operations performed in the control device 10. FIG. 6 is a flowchart for explaining an example of the operations performed in the control device 10 according to the present embodiment.

As illustrated in FIG. 6, firstly, the first external controller 20A or the second external controller 20B issues an instruction to switch the operation controlling entity for the robot device 30 (S110). Then, the control device 10 receives a first-type driving instruction and a second-type driving instruction from the first external controller 20A and the second external controller 20B, respectively (S120). Subsequently, based on a transition function, the control device 10 performs weighted synthesis of the first-type driving instruction and the second-type driving instruction received from each of the first external controller 20A and the second external controller 20B, respectively (S130). As a result, the control device 10 becomes able to generate a transition driving instruction for controlling the driving of the robot device 30 in any intermediate state at the time switching the operation controlling entity between the first external controller 20A and the second external controller 20B.

Then, based on the transition driving instruction that is generated, the control device 10 controls the driving of the robot device 30 (S140). Herein, the control device 10 determines whether the weighting in the transition driving instruction has become equal to “0” or “1” and determines whether the operation controlling entity for the robot device 30 has switched to either the first external controller 20A or the second external controller 20B (S150). If the operation controlling entity is not yet switched (No at S150), the control device 10 makes monotonic variation in the weighting (S160). Subsequently, the system control returns to Step S120, and the control device 10 generates a transition driving instruction by synthesizing the first-type driving instruction and the second-type driving instruction.

When the operation controlling entity is switched (Yes at S150), the control device 10 notifies the first external controller 20A and the second external controller 20B about the completion of the switching of the operation controlling entity for the robot device 30 (S170). As a result, the control device 10 ends the switching of the operation controlling entity for the robot device 30 between the first external controller 20A and the second external controller 20B.

Explained below with reference to FIG. 7 is the communication between the control device 10 and the first external controller 20A or the second external controller 20B. FIG. 7 is a sequence diagram illustrating an example of the operations performed in the control device 10 according to the present embodiment.

As illustrated in FIG. 7, firstly, assume that the robot device 30 is being operated according to a driving instruction issued by the first external controller 20A (S201). Thus, the first external controller 20A has already sent a first-type driving instruction to the control device 10 (S203), and the control device 10 is controlling the driving of the robot device 30 based on the received first-type driving instruction (S205).

Herein, for example, assume that the second external controller 20B issues an instruction to switch the operation controlling entity for the robot device 30 from the first external controller 20A to the second external controller 20B (S207). The control device 10 notifies the first external controller 20A about switching the operation controlling entity for the robot device 30 from the first external controller 20A to the second external controller 20B (S209).

Subsequently, the operations to be performed by the robot device 30 are input to each of the first external controller 20A and the second external controller 20B (S211 and S215), and a first-type driving instruction and a second-type driving instruction corresponding to the input operations are sent to the control device 10 (S213 and S217). The control device 10 performs weighted synthesis of each of the first-type driving instruction and the second-type driving instruction, and generates a transition driving instruction (S219). Then, based on the transition driving instruction, the control device 10 controls the driving of the robot device 30 (S221).

The control device 10 generates a transition driving instruction while making monotonic variation of the weighting till the weighting reaches “0” or “1”; and controls the driving of the robot device 30 based on the transition driving instruction (S223). When the weighting reaches “0” or “1”, the control device 10 determines that the switching of the operation controlling entity for the robot device 30 is completed (S225).

Subsequently, the control device 10 notifies each of the first external controller 20A and the second external controller 20B about the completion of the switching of the operation controlling entity for the robot device 30 (S227 and S231). As a result, in the first external controller 20A, the operation of the robot device 30 is ended (S229). On the other hand, the operation of the robot device 30 is continued in the second external controller 20B (S233), and the second-type driving instruction that is input to the second external controller 20B is sent to the control device 10 (S235). As a result, the control device 10 controls the driving of the robot device 30 based on the second-type driving instruction (S237).

As explained above, in the control device 10 according to the present embodiment, at the time of switching the operation controlling entity for the robot device 30, it becomes possible to switch the operation controlling entity while maintaining the task states of the tasks being performed in the robot device 30.

### 5. Modification Examples

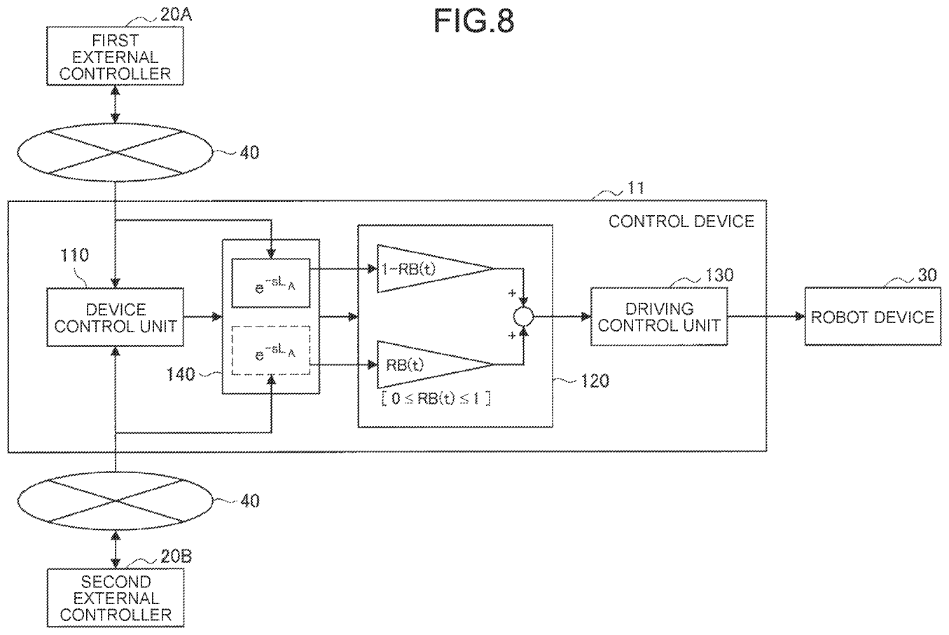

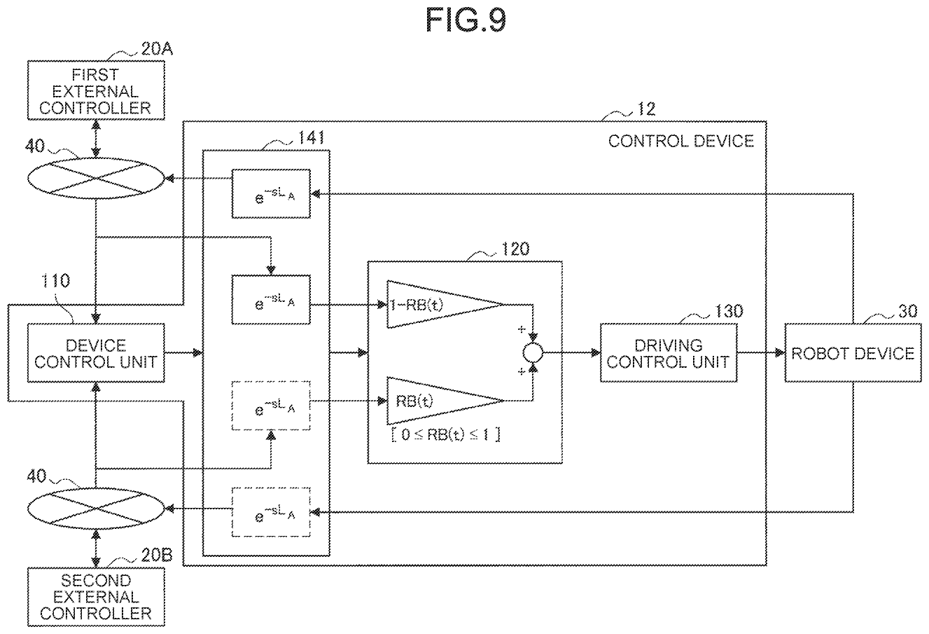

Explained below with reference to FIGS. 8 and 9 are modification examples of the control device 10 according to the present embodiment.

### First Embodiment

Firstly, explained below with reference to FIG. 8 is a first modification example of the control device 10. FIG. 8 is a block diagram illustrating a specific example of the functional configuration of a control device 11 according to the first modification example.

As illustrated in FIG. 8, the control device 11 according to the first modification example additionally includes a delay managing unit 140 as against the control device 10 illustrated in FIG. 3. The remaining configuration of the control device 11 according to the first modification example is identical to the control device 10 illustrated in FIG. 3. Hence, that explanation is not given again.

In the following explanation, it is assumed that the communication delay between the first external controller 20A and the robot device 30 is greater than the communication delay between the second external controller 20B and the robot device 30. Of course, it goes without say that the first external controller 20A and the second external controller 20B can have a reversed magnitude relationship of the communication delays.

The delay managing unit 140 corrects the mismatch in the communication delay for the first external controller 20A and the communication delay for the second external controller 20B. More particularly, based on the delay period of the communication as measured by the device control unit 110, the delay managing unit 140 adds dead time to the driving instruction having the smaller communication delay from among the first-type driving instruction and the second-type driving instruction. With that, the delay managing unit 140 corrects the mismatch caused in the timings of the first-type driving instruction and the second-type driving instruction due to the communication delays.

At the time of switching from the first-type driving instruction to the second-type driving instruction, the robot device 30 is controlled according to the transition driving instruction that is formed by synthesizing the first-type driving instruction and the second-type driving instruction. For that reason, when a mismatch is caused in the timings of the first-type driving instruction and the second-type driving instruction due to the communication delays, the transition control unit 120 may find it difficult to generate a transition driving instruction in an appropriate manner.

In that regard, in the control device 11 according to the first modification example, the delay managing unit 140 adjusts the timings of the first-type driving instruction and the second-type driving instruction, so that a transition driving instruction can be generated in an appropriate manner. For example, as illustrated in FIG. 8, the delay managing unit 140 can add dead time “exp(−sL_{A})” to the first-type driving instruction received from the first external controller 20A, and can correct the mismatch in the timings of the first-type driving instruction and the second-type driving instruction.

Herein, using Equations 2 and 3 given below, L_{A} can be calculated from the delay time measured by the device control unit 110 that manages the communication with the first external controller 20A and the second external controller 20B. In Equations 2 and 3, T_{A} represents the magnitude of the communication delay between the first external controller 20A and the robot device 30, and T_{B} represents the magnitude of the communication delay between the first external controller 20A and the robot device 30.

L_{A}=L_{B}−T_{A}(T_{B}>T_{A}) Equation 2

L_{A}=0(T_{B}≤T_{A}) Equation 3

When there is a large communication delay between the first external controller 20A or the second external controller 20B and the robot device 30, it may affect the responsiveness and the stability of the robot device 30. However, the impact of the communication delay is dependent on the magnitude of the communication delay, the manner of operating the robot device 30, the configuration of the robot device 30, and the contents and the environment of the tasks performed by the robot device 30. Hence, it is difficult to estimate in advance the impact of the communication delay between the first external controller 20A or the second external controller 20B and the robot device 30, before sending a driving instruction.

In that regard, for example, in the case of switching the operation controlling entity for the robot device 30 from the first external controller 20A to the second external controller 20B that has a greater communication delay, it is desirable to confirm whether the robot device 30 is appropriately remote-controlled using the post-switching second external controller 20B.

In the control device 11 according to the first modification example, as a result of using the delay managing unit 140, the status of the communication delay in the case in which the robot device 30 is remote-controlled by the second external controller 20B can be replicated while retaining the involvement from the first external controller 20A. Hence, before switching the operation controlling entity for the robot device 30 to the second external controller 20B, the control device 11 according to the first modification example becomes able to determine about whether or not the robot device 30 is remote-controllable with the communication delay of the second external controller 20B.

Meanwhile, when there is a communication delay between the first external controller 20A or the second external controller 20B and the robot device 30, the control device 11 can set, based on the magnitude of the communication delay, the transition period at the time of switching the operation controlling entity for the robot device 30. When the transition period at the time of switching the operation controlling entity for the robot device 30 is shorter than the delay time, it may affect the responsiveness and the stability of the robot device 30. Hence, at the time of switching the operation controlling entity for the robot device 30, the control device 11 can set the transition period to be longer than the greater communication delay from among the communication delays of the first external controller 20A and the second external controller 20B with respect to the robot device 30.

### Second Modification Example

Explained below with reference to FIG. 9 is a second modification example of the control device 10. FIG. 9 is a block diagram illustrating a specific example of the functional configuration of a control device 12 according to the second modification example.

As illustrated in FIG. 9, the control device 12 according to the second modification example differs from the control device 11 illustrated in FIG. 8 in the way of giving feedback of sensing information to the first external controller 20A or the second external controller 20B. Moreover, the control device 12 according to the second modification example includes a delay managing unit 141 that, also with respect to the sensing information, corrects the mismatch in the timings of feedback. The remaining configuration of the control device 12 according to the second modification example is identical to the control device 10 illustrated in FIG. 3. Hence, that explanation is not given again.

More particularly, in the control device 12 according to the second modification example, the sensing information obtained by sensors installed in the robot device 30 is fed back to the operator of the first external controller 20A or the operator of the second external controller 20B. Examples of the sensing information that is fed back to the operator of the first external controller 20A or the operator of the second external controller 20B include sensing information obtained by a force sensor, a tactile sensor, an imaging device, a proximity sensor, a ranging sensor, a pressure sensor, or a temperature sensor installed in the robot device 30.

At that time, in an identical manner to the correction of the communication delays of the first-type driving instruction and the second-type driving instruction, the delay managing unit 141 corrects the communication delay also regarding the sensing information that is sent to the first external controller 20A or the second external controller 20B. As a result, the control device 12 according to the second modification example becomes able to feedback the sensing information to the first external controller 20A or the second external controller 20B, with the timings matched with each other.

Moreover, when the sensing information is fed back from the robot device 30 to the first external controller 20A or the second external controller 20B, the control device 12 can set the transition period, at the time of switching the operation controlling entity for the robot device 30, based on the sampling frequency of the sensing information. For example, if the sensing information to be fed back to the first external controller 20A or the second external controller 20B has the sampling frequency of 1 Hz; then the transition period, at the time of switching the operation controlling entity for the robot device 30, can be set to be equal to or greater than one second. If the transition period, at the time of switching the operation controlling entity for the robot device 30, is shorter than one cycle of the sampling frequency of the sensing information; then the feedback of the sensing information from the robot device 30 cannot be received before the completion of the switching of the operation controlling entity for the robot device 30. Hence, the transition period, at the time of switching the operation controlling entity for the robot device 30, can be set to be longer than the period of time of a single cycle of the sampling frequency of the sensing information.

### 6. Exemplary Hardware Configuration

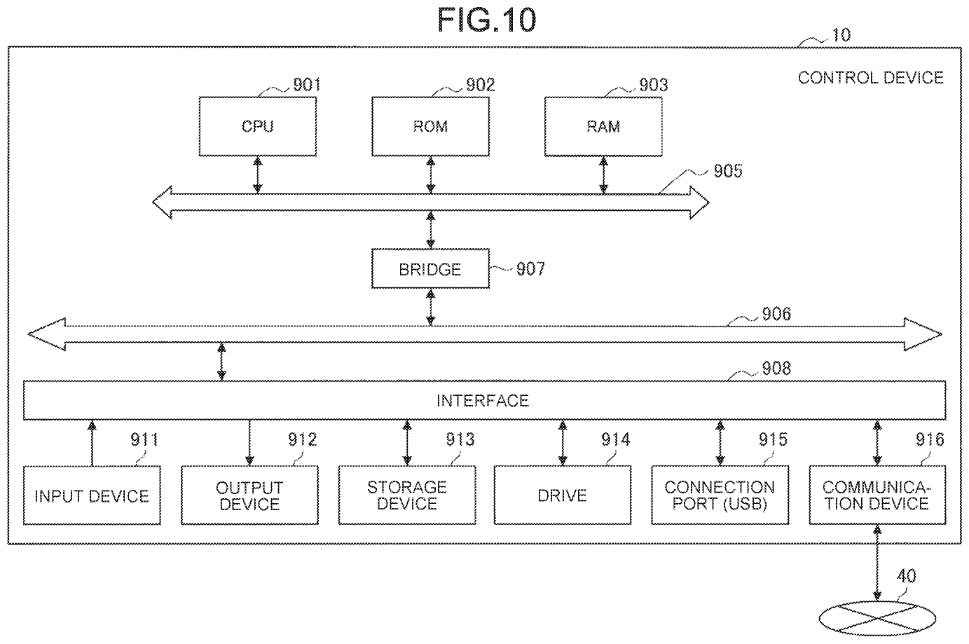

Explained below with reference to FIG. 10 is a hardware configuration of the control device 10 according to the present embodiment. FIG. 10 is a block diagram illustrating an exemplary hardware configuration of the control device 10 according to the present embodiment.

As illustrated in FIG. 10, the control device 10 includes a CPU (Central Processing Unit) 901, a ROM (Read Only Memory) 902, a RAM (Random Access Memory) 903, a bridge 907, internal buses 905 and 906, an interface 908, an input device 911, an output device 912, a storage device 913, a drive 914, a connection port 915, and a communication device 916.

The CPU 901 functions as an arithmetic processing device and controls the overall operations of the control device 10 according to various programs stored in the ROM 902. The ROM 902 is used to store programs and operation parameters used by the CPU 901. The RAM 903 is used to temporarily store the programs used by the CPU 901 during execution, and to temporarily store the parameters that undergo appropriate changes during the execution. The CPU 901 can implement the functions of, for example, the device control unit 110, the transition control unit 120, the driving control unit 130, and the delay managing unit 140.

The CPU 901, the ROM 902, and the RAM 903 are connected to each other by the bridge 907 and the internal buses 905 and 906. Moreover, the CPU 901, the ROM 902, and the RAM 903 are also connected to the input device 911, the output device 912, the storage device 913, the drive 914, the connection port 915, and the communication device 916 via the interface 908.

The input device 911 includes an input device such as a touch-sensitive panel, a keyboard, a mouse, a button, a microphone, a switch, or a lever in which information is input. Moreover, the input device 911 includes an input control circuit that generates input signals based on the input information, and outputs the input signals to the CPU 901.

The output device 912 includes a display device such as a CRT (Cathode Ray Tube) display device, a liquid crystal display device, or an organic EL (Organic ElectroLuminescence) display device. Moreover, the output device 912 can also include a sound output device such as a speaker or headphones.

The storage device 913 is a memory device used to store data of the control device 10. The storage device 913 can include a memory medium, a memory device for storing data in the memory medium, a reading device for reading data from the memory medium, and a deleting device for deleting the stored data.

The drive 914 is a reader/writer for memory mediums, and either can be embedded in the control device 10 or can be externally attached to the control device 10. For example, the drive 914 reads information stored in a removable memory medium such as a magnetic disk, an optical disk, a magneto-optical disk, or a semiconductor memory that is inserted; and outputs the read information to the RAM 903. The drive 914 can also write information in a removable memory medium.

The connection port 915 is a connection interface such as a USB (Universal Serial Bus) port, an Ethernet (registered trademark) port, an IEEE 802. 11 standard port, or an optical audio terminal that enables establishing connection with an external connection device.

The communication device 916 is a communication interface configured using a communication device for establishing connection with the network 40. Moreover, the communication device 916 can be a communication device compatible to a wired LAN or a wireless LAN, or can be a cable communication device that performs wired cable communication.

Meanwhile, it is also possible to create a computer program by which the hardware including the CPU, the ROM, and the RAM embedded in the control device 10 implements functions equivalent to the configuration of the control device according to the present embodiment. Moreover, it is possible to provide a memory medium in which that computer program is stored.

Although the application concerned is described above in detail in the form of an embodiment with reference to the accompanying drawings; the technical scope of the application concerned is not limited to the embodiment described above. That is, the application concerned is to be construed as embodying all modifications such as other embodiments, additions, alternative constructions, and deletions that may occur to one skilled in the art that fairly fall within the basic teaching herein set forth. In any form thereof, as long as the functions/effects of the application concerned are achieved, the modifications are included in the scope of the application concerned.

The effects described in the present written description are only explanatory and exemplary, and are not limited in scope. That is, in addition to or in place of the effects described above, the technology disclosed in the application concerned enables achieving other effects that may occur to one skilled in the art.

Meanwhile, a configuration as explained below also falls within the technical scope of the application concerned.
(1) A control device comprising:

a driving control unit that drives a robot device based on one of a first-type driving instruction and a second-type driving instruction, at least one of which is sent from a distant location from the robot device; and

a transition control unit that switches a driving instruction for driving the robot device from the first-type driving instruction to the second-type driving instruction, wherein the transition control unit switches the driving instruction from the first-type driving instruction to the second-type driving instruction via a transition driving instruction generated based on the first-type driving instruction and the second-type driving instruction.
(2) The control device according to (1), wherein the transition driving instruction is generated by performing weighted synthesis of the first-type driving instruction and the second-type driving instruction based on a transition function.
(3) The control device according to (2), wherein the transition function is a function that undergoes a monotonic increase or a monotonic decrease.
(4) The control device according to any one of (1) to (3), wherein at least either the first-type driving instruction or the second-type driving instruction is sent from the distant location at which a communication delay occurs in communication with the robot device.
(5) The control device according to (4), further comprising a delay managing unit that corrects a mismatch caused in timings of the first-type driving instruction and the second-type driving instruction due to the communication delay.
(6) The control device according to (4) or (5), wherein a transition period for switching from the first-type driving instruction to the second-type driving instruction via the transition driving instruction is set based on a delay amount of the communication delay.
(7) The control device according to any one of (1) to (6), wherein one of the first-type driving instruction and the second-type driving instruction is a driving instruction input to an input device by a first operator at the distant location.
(8) The control device according to (7), further comprising a device control unit that autonomously generates a driving instruction for the robot device, wherein other of the first-type driving instruction and the second-type driving instruction is a driving instruction generated by the device control unit.
(9) The control device according to (7), wherein other of the first-type driving instruction and the second-type driving instruction is a driving instruction input to an input device by a second operator at a distant location that is different than the distant location of the first operator.
(10) The control device according to (9), wherein the robot device feeds back sensing information to the first operator or the second operator.
(11) The control device according to (10), wherein a communication delay occurs in communication between the distant location, at which the first operator or the second operator is present, and the robot device, and the control device further comprises a delay managing unit that corrects a mismatch caused in timing of feedback of the sensing information due to the communication delay.
(12) The control device according to (10) or (11), wherein a transition period for switching from the first-type driving instruction to the second-type driving instruction via the transition driving instruction is set based on a sampling frequency of the sensing information.
(13) The control device according to any one of (7) to (12), wherein, based on operation performed by the first operator, the transition control unit either stops or finishes switching from the first-type driving instruction to the second-type driving instruction.
(14) The control device according to any one of (1) to (13), wherein, based on at least either a state of communication with the distant location or a state of the robot device, the transition control unit stops switching from the first-type driving instruction to the second-type driving instruction.
(15) A control method implemented in an arithmetic processing device, the control method comprising:

driving a robot device based on a first-type driving instruction from among the first-type driving instruction and a second-type driving instruction, at least one of which is sent from a distant location from the robot device; and

switching a driving instruction for driving the robot device from the first-type driving instruction to the second-type driving instruction via a transition driving instruction generated based on the first-type driving instruction and the second-type driving instruction.
(16) A program that causes a computer to function as:

a driving control unit that drives a robot device based on one of a first-type driving instruction and a second-type driving instruction, at least one of which is sent from a distant location from the robot device; and

a transition control unit that switches driving instruction for driving the robot device from the first-type driving instruction to the second-type driving instruction,

wherein the program causes the transition control unit to switch a driving instruction from the first-type driving instruction to the second-type driving instruction via a transition driving instruction generated based on the first-type driving instruction and the second-type driving instruction.

### REFERENCE SIGNS LIST

10 control device
20-1 to 20-N external controller
20A first external controller
20B second external controller
30 robot device
40 network
110 device control unit
120 transition control unit
130 driving control unit
140 delay managing unit

1. A control device comprising:
a driving control unit that drives a robot device based on one of a first-type driving instruction and a second-type driving instruction, at least one of which is sent from a distant location from the robot device; and
a transition control unit that switches a driving instruction for driving the robot device from the first-type driving instruction to the second-type driving instruction, wherein the transition control unit switches the driving instruction from the first-type driving instruction to the second-type driving instruction via a transition driving instruction generated based on the first-type driving instruction and the second-type driving instruction.

2. The control device according to claim 1, wherein the transition driving instruction is generated by performing weighted synthesis of the first-type driving instruction and the second-type driving instruction based on a transition function.

3. The control device according to claim 2, wherein the transition function is a function that undergoes a monotonic increase or a monotonic decrease.

4. The control device according to claim 1, wherein at least either the first-type driving instruction or the second-type driving instruction is sent from the distant location at which a communication delay occurs in communication with the robot device.

5. The control device according to claim 4, further comprising a delay managing unit that corrects a mismatch caused in timings of the first-type driving instruction and the second-type driving instruction due to the communication delay.

6. The control device according to claim 4, wherein a transition period for switching from the first-type driving instruction to the second-type driving instruction via the transition driving instruction is set based on a delay amount of the communication delay.

7. The control device according to claim 1, wherein one of the first-type driving instruction and the second-type driving instruction is a driving instruction input to an input device by a first operator at the distant location.

8. The control device according to claim 7, further comprising a device control unit that autonomously generates a driving instruction for the robot device, wherein other of the first-type driving instruction and the second-type driving instruction is a driving instruction generated by the device control unit.

9. The control device according to claim 7, wherein other of the first-type driving instruction and the second-type driving instruction is a driving instruction input to an input device by a second operator at a distant location that is different than the distant location of the first operator.

10. The control device according to claim 9, wherein the robot device feeds back sensing information to the first operator or the second operator.

11. The control device according to claim 10, wherein a communication delay occurs in communication between the distant location, at which the first operator or the second operator is present, and the robot device, and the control device further comprises a delay managing unit that corrects a mismatch caused in timing of feedback of the sensing information due to the communication delay.

12. The control device according to claim 10, wherein a transition period for switching from the first-type driving instruction to the second-type driving instruction via the transition driving instruction is set based on a sampling frequency of the sensing information.

13. The control device according to claim 7, wherein, based on operation performed by the first operator, the transition control unit either stops or finishes switching from the first-type driving instruction to the second-type driving instruction.

14. The control device according to claim 1, wherein, based on at least either a state of communication with the distant location or a state of the robot device, the transition control unit stops switching from the first-type driving instruction to the second-type driving instruction.

15. A control method implemented in an arithmetic processing device, the control method comprising:
driving a robot device based on a first-type driving instruction from among the first-type driving instruction and a second-type driving instruction, at least one of which is sent from a distant location from the robot device; and
switching a driving instruction for driving the robot device from the first-type driving instruction to the second-type driving instruction via a transition driving instruction generated based on the first-type driving instruction and the second-type driving instruction.

16. A program that causes a computer to function as:
a driving control unit that drives a robot device based on one of a first-type driving instruction and a second-type driving instruction, at least one of which is sent from a distant location from the robot device; and
a transition control unit that switches driving instruction for driving the robot device from the first-type driving instruction to the second-type driving instruction,
wherein the program causes the transition control unit to switch a driving instruction from the first-type driving instruction to the second-type driving instruction via a transition driving instruction generated based on the first-type driving instruction and the second-type driving instruction.
